(19) United States
(12) Patent Application Publication
(10) Pub. No.: US 2025/0227834 A1
(43) Pub. Date: Jul. 10, 2025

(54) HIGH PRESSURE COUPLING ASSEMBLY

(71) Applicant: ASML Netherlands B.V., Veldhoven (NL)

(72) Inventors: Rahul Sunil Kapadia, San Diego, CA (US); Ethan Marcus Swerdlow, San Diego, CA (US); Georgiy Olegovich Vaschenko, San Diego, CA (US); Ian Roger Oliver, Escondido, CA (US); Chirag Rajyaguru, San Diego, CA (US); Dietmar Uwe Hubert Trees, San Diego, CA (US); Benjamin Andrew Sams, San Diego, CA (US); Theodorus Wilhelmus Driessen, Asten-Heusden (NL); Vikas Giridhar Telkar, Escondido, CA (US); Alexander Igorevich Ershov, Escondido, CA (US)

(21) Appl. No.: 18/853,562

(22) PCT Filed: Mar. 20, 2023
(86) PCT No.: PCT/EP2023/057024

§ 371 Date: Oct. 2, 2024

Related U.S. Application Data
(60) Provisional application No. 63/443,496, filed on Feb. 6, 2023.
(60) Provisional application No. 63/329,938, filed on Apr. 12, 2022.

(51) Int. Cl. H05G 2/00; F16L 21/00

(52) U.S. Cl. CPC H05G 2/0092; F16L 21/002; H05G 2/008

(57) ABSTRACT

A target material generator includes a fluid flow path between reservoir system and a nozzle supply system, and a coupling assembly in the fluid flow path. The target material generator is a part of an extreme ultraviolet light source. The coupling assembly includes a first fitting coupled to a second fitting to thereby form a flow conduit along the fluid flow path, wherein a seal is formed between the first fitting and the second fitting, and a sleeve disposed along inner walls of the flow conduit and between the seal and the flow conduit such that a contaminant trap is formed between the sleeve and the seal.

### CROSS REFERENCE TO RELATED APPLICATIONS

This application claims priority to U.S. Application No. 63/329,938, filed Apr. 12, 2022, titled HIGH PRESSURE COUPLING ASSEMBLY; and U.S. Application No. 63/443,496, filed Feb. 6, 2023, titled HIGH PRESSURE COUPLING ASSEMBLY, both of which are incorporated herein in their entireties by reference.

### TECHNICAL FIELD

The disclosed subject matter relates to a high pressure coupling assembly for a target material supply apparatus.

### BACKGROUND

Extreme ultraviolet (EUV) light, for example, electromagnetic radiation having wavelengths of 100 nanometers (nm) or less (also sometimes referred to as soft x-rays), and including light at a wavelength of, for example, 20 nm or less, between 5 and 20 nm, or between 13 and 14 nm, can be used in photolithography processes to produce extremely small features in substrates, for example, silicon wafers, by initiating polymerization in a resist layer. Methods for generating EUV light include, but are not limited to, altering the physical state of a source material to a plasma state. The source material includes a compound or an element, for example, xenon, lithium, or tin, with an emission line in the EUV range. In one such method, often termed laser produced plasma (“LPP”), the required plasma is produced by irradiating a source material, for example, in the form of a droplet, stream, or cluster of source material, with an amplified light beam that can be referred to as a drive laser. For this process, the plasma is typically produced in a sealed vessel, for example, a vacuum chamber, and monitored using various types of metrology equipment. The source material, such as xenon, lithium, or tin, which emit in the EUV range when in the plasma state, are commonly referred to as target material since they are targeted and irradiated by the drive laser.

### SUMMARY

In some general aspects, a high pressure coupling assembly includes: a first fitting coupled to a second fitting and forming a molten tin flow conduit therebetween; a polyimide sealing member disposed between the first and second fittings; and a tantalum sleeve disposed along inner walls of the conduit and disposed between the polyimide sealing member and the conduit. The tantalum sleeve is coupled to one or more of the first and second fittings by press-fitting or threading.

Implementations can include one or more of the following features. For example, the first fitting and the second fitting can include or be made of molybdenum. The tantalum sleeve can be a non-sealing sleeve. The polyimide sealing member can be configured to maintain a hermetic seal up to pressures greater than 10,000 pounds per square inch (PSI), greater than 20,000 PSI, or greater than 30,000 PSI. An outer diameter of the tantalum sleeve can be less than a diameter of the tin flow conduit. The tantalum sleeve can extend a length along the tin flow conduit that is greater than a length along which the polyimide sealing member extends.

In other general aspects, a coupling assembly is used in an extreme ultraviolet light source target material generator. The coupling assembly includes: a first fitting coupled to a second fitting and forming a flow conduit therebetween, and a seal is formed between the first fitting and the second fitting; and a sleeve disposed along inner walls of the conduit and between the seal and the flow conduit such that a contaminant trap is formed between the sleeve and the seal.

Implementations can include one or more of the following features. For example, the sleeve can be coupled to one or more of the first fitting and the second fitting by press-fitting or threading.

The coupling assembly can further include a sealing device disposed between the first fitting and the second fitting, the sealing device forming the seal between the first fitting and the second fitting. The sealing device can include a gasket placed between the first fitting and the second fitting. The gasket can include or be made of polyimide.

The first fitting and the second fitting can be press fitted together or can be threaded together to thereby form the seal at the interface between the first fitting and the second fitting. The first fitting and the second fitting can include or be made of a refractory metal. The refractory metal of the first fitting and the second fitting can include molybdenum.

The sleeve can include or be made of a material that is compatible with fluid flowing within the flow conduit. The sleeve can be configured to trap contaminants, some of which are formed from the interaction between the seal and a target material flowing within the flow conduit. The sleeve can include or be made of a refractory metal. The refractory metal can be tantalum.

The seal can be directly formed between a first conical surface of the first fitting and a second conical surface of the second fitting when the first conical surface and the second conical surface are frictionally engaged.

The sleeve can be an annular gasket positioned between the first fitting and the second fitting. The coupling assembly can further include a sealing gasket disposed between the first fitting and the second fitting, the sealing gasket forming the seal between the first fitting and the second fitting. The annular gasket can include tantalum and the sealing gasket can include polyimide. The annular gasket can be disposed concentrically inside the sealing gasket. A width of the sealing gasket, when in a relaxed state, can be greater than a width of the annular gasket, when in a relaxed state.

In other general aspects, a target material generator is used for an extreme ultraviolet light source. The target material generator includes: a fluid flow path between reservoir system and a nozzle supply system; and a coupling assembly in the fluid flow path. The coupling assembly includes: a first fitting coupled to a second fitting to thereby form a flow conduit along the fluid flow path, wherein a seal is formed between the first fitting and the second fitting; and a sleeve disposed along inner walls of the flow conduit and between the seal and the flow conduit such that a contaminant trap is formed between the sleeve and the seal.

Implementations can include one or more of the following features. For example, the fluid flow path can provide a path for target material from the reservoir system to and through the nozzle supply system. The target material can include or be made of tin or a tin alloy. The sleeve can be coupled to the first and second fittings by press-fitting or threading. The coupling assembly can include a sealing device disposed between the first fitting and the second fitting, the sealing device forming the seal between the first fitting and the second fitting. The sealing device can include a gasket placed between the first fitting and the second fitting. The first fitting and the second fitting can be press fitted together or can be threaded together to thereby form the seal at the interface between the first fitting and the second fitting. The first fitting and the second fitting can include or be made of a refractory metal. The sleeve can include a material that is compatible with target material flowing along the fluid flow path between the reservoir system and the nozzle supply system. The sleeve can be configured to trap contaminants, some of which are formed from the interaction between the seal and a target material flowing within the flow conduit and along the fluid flow path between the reservoir and the nozzle supply system.

### DESCRIPTION OF DRAWINGS

FIG. 1A is a side cross-sectional view of a coupling assembly for use in a target material generator, the coupling assembly including a sleeve disposed between a seal and a flow conduit through which target material passes;

FIG. 1B is an axial cross-sectional view of the coupling assembly of FIG. 1A taken along line 1B-1B;

FIG. 2 is a block diagram showing the coupling assembly of FIG. 1A incorporated within a target material generator that supplies target material to an external system;

FIG. 3 is a side cross-sectional view of an implementation of the coupling assembly of FIGS. 1A and 1B, in which the seal is formed from a sealing device disposed along a radial interface between a first fitting and a second fitting, and the sleeve includes an annular protrusion that is press fit at one end inside the first fitting;

FIG. 4A is a perspective side view of an implementation of the sleeve of the coupling assembly of FIG. 3;

FIG. 4B is a perspective side view of another implementation of the sleeve of the coupling assembly of FIG. 3;

FIG. 5 is a side cross-sectional view of an implementation of the coupling assembly of FIGS. 1A and 1B, in which the seal is formed from a sealing device disposed along a radial interface between a first fitting and a second fitting, and the sleeve includes a pair of annular protrusions, each annular protrusion being press fit inside respective first and second fittings;

FIG. 6A is a perspective side view of the sleeve of the coupling assembly of FIG. 5;

FIG. 6B is a close up of the side cross-sectional view of FIG. 5 showing details of the sealing device and the sleeve;

FIG. 7A is a side cross-sectional view of an implementation of the coupling assembly of FIGS. 1A and 1B, in which the sleeve is formed as an annular shoulder machined into a first fitting and is at a radial interface between the first fitting and the second fitting, and a seal is formed from a sealing device disposed along the radial interface;

FIG. 7B is a close up of the side cross-sectional view of FIG. 7A showing details of the sleeve and the seal;

FIG. 8A is a side cross-sectional view of an implementation of the coupling assembly of FIGS. 1A and 1B, in which the seal is a cone and thread seal, and is formed at an interface between two conical and angled surfaces of respective first fitting and second fitting, and the sleeve fits within a cavity that is formed by respective recesses of the first fitting and the second fitting;

FIG. 8B is a close up of the side cross-sectional view of FIG. 8A showing details of the sleeve and the seal;

FIG. 9 is a block diagram of an implementation of the target material generator of FIG. 2, in which the coupling assembly is placed in the fluid flow path of the target material from a reservoir system to a nozzle supply apparatus;

FIG. 10A is a side cross-sectional view of an implementation of the coupling assembly of FIG. 7A, in which the sleeve is formed as an annular gasket at a radial interface between the first fitting and the second fitting, and a seal is formed from a sealing device disposed along the radial interface;

FIGS. 10B and 10C are close-up views of the side cross-sectional view of FIG. 10A showing details of the sleeve and the seal, where FIG. 10B depicts the annular gasket and the sealing device before the application of pressure from a coupling force and FIG. 10C depicts the annular gasket and the sealing device after the application of pressure from a coupling force; and

FIGS. 10D and 10E are close-up views of, respectively, FIGS. 10B and 10C.

### DESCRIPTION

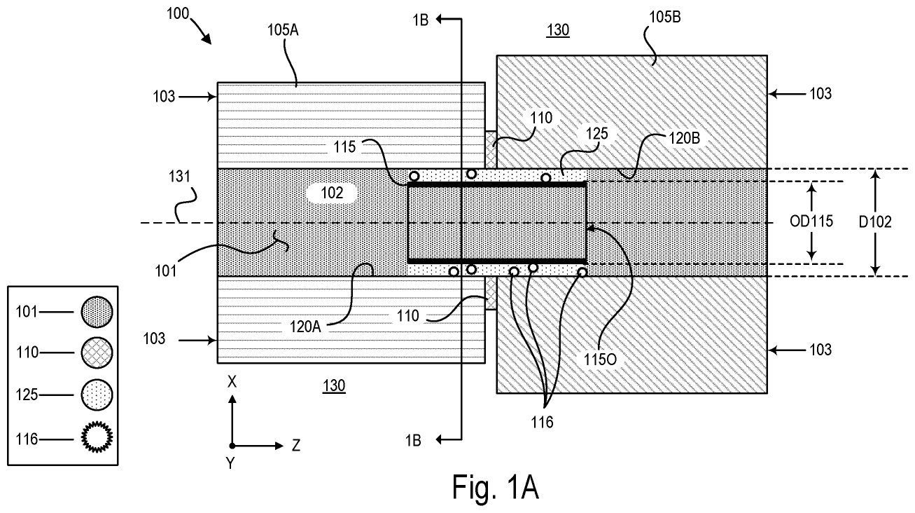

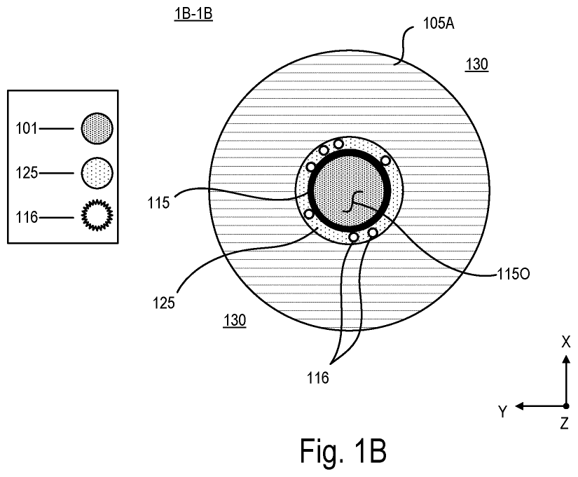

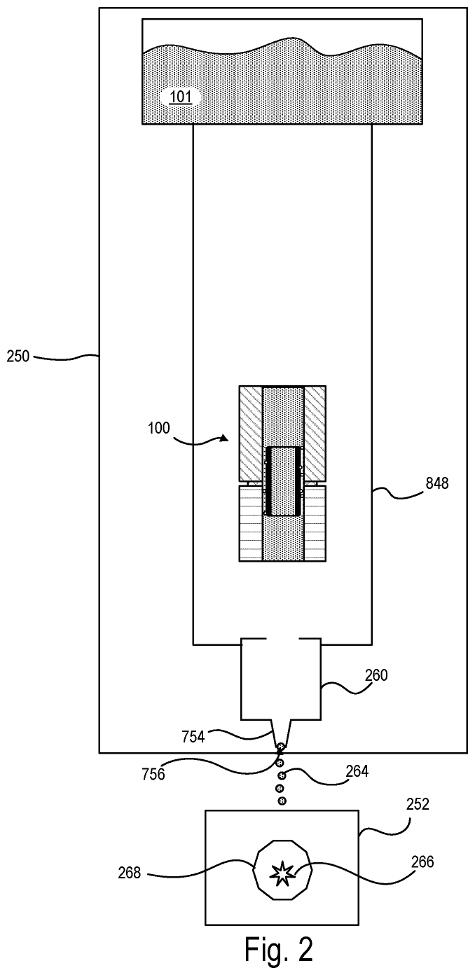

Referring to FIGS. 1A, 1B, and 2, a coupling assembly 100 can be used in a target material generator 250 (FIG. 2) that is configured to supply target material 101 to an external system 252 (FIG. 2). The target material generator 250 includes a target transport system 848 and a nozzle supply apparatus 260 fluidly communicating with the target transport system 848. As shown in FIGS. 1A and 1B, the coupling assembly 100 provides a passage or flow conduit 102 through which this target material 101 passes on the way to the external system 252. The coupling assembly 100 is therefore a fitting wetted with the target material 101. The coupling assembly 100 includes a first fitting 105A and a second fitting 105B that, when coupled together by a force 103, forms the flow conduit 102 therebetween. In particular, the flow conduit 102 is formed by and defined by inner walls 120A, 120B of respective first fitting 105A and second fitting 105B. The target material 101 generally travels through the second fitting 105B and then through the first fitting 105A along an axial direction 131 on the way to the external system 252. The axial direction 131 is generally parallel with a Z axis of an X, Y, Z Cartesian coordinate system. The direction of flow of the target material 101 is parallel with a -Z direction (that lies along the Z axis) and thus the target material 101 flows from inside of the second fitting 105B to inside of the first fitting 105A. The target material 101 is a fluid, which can be a liquid or a gas.

A seal 110 is formed between the first fitting 105A and the second fitting 105B. The seal 110 is a hermetic seal that is able to prevent materials from passing between the first fitting 105A and the 10 second fitting 105B and is also able to withstand a pressure differential. The coupling assembly 100 includes a sleeve 115 disposed along the inner walls 120A, 120B (of the respective first and second fittings 105A, 105B) that define the flow conduit 102. The sleeve 115 is between the seal 110 and the flow conduit 102 such that a region 125 is formed between the sleeve 115 and the seal 110. The sleeve 115 is hollow and therefore includes an opening 1150 that aligns with the flow conduit 102 15 and generally extends along the axial direction 131. As shown in FIG. 1B, the sleeve 115 and the flow conduit 102 are cylindrical in shape with the axis aligning with the axial direction 131.

The coupling assembly 100 is designed with an architecture that divides functions between the seal 110 and the sleeve 115. First, the seal 110 provides the function of sealing, that is, to maintain a pressure differential between the flow conduit 102 and an exterior 130 of the coupling assembly 20 100. The seal 110 is configured to prevent or reduce leaks between the flow conduit 102 and the exterior 130, that is, to keep the target material 101 within the flow conduit 102 and to prevent materials from the exterior 130 to enter the flow conduit 102.

Second, the sleeve 115 provides the function of a contaminant trap within the region 125. The sleeve 115 is configured to trap unwanted matter 116 within the region 125, and by trapping this 25 unwanted matter 116 within the region 125, the sleeve 115 reduces pollution within the flow conduit 102. The sleeve 115 is non-hermetically-sealing, and thus is not able to maintain a pressure differential between this region 125 and the flow conduit 102. The sleeve 115 can be configured to trap some small particles, and can, in some implementations, act as a particle seal, depending on the fit between the sleeve 115 and the flow conduit 102. The reduction of this pollution in the flow 30 conduit 102 reduces pollution along the flow path within the target material generator 250 and also within the external system 252 and therefore reduces failures of components (within the target material generator 250) that are in fluid communication with the flow conduit 102 and exposed to the target material 101. Unwanted matter 116 can be formed from the interaction between the target material 101 flowing through the flow conduit 102 and the seal 110. For example, target material 101 35 can oxidize when it interacts with oxygen or moisture that permeates through the seal 110 and this oxidized target material is unwanted matter 116.

In this way, the seal 110 can be designed with a material that is excellent at providing a high pressure seal and also excellent at resisting the corrosive nature of the target material 101, even if such a material is not able to adequately prevent moisture and oxygen permeation between the exterior 130 and the flow conduit 102. On the other hand, the sleeve 115 can be designed in a non-sealing manner (as discussed above) and using a material that need not function for sealing purposes but that nevertheless acts as a particle barrier, preventing particles within the region 125 from entering the flow conduit 102. The sleeve 115 is designed to trap any oxidized target material 101 that is formed from this moisture permeation. Together, the seal 110 and the sleeve 115 function to provide all three of these functions (the high-pressure seal, the corrosion resistance, and the trap for unwanted matter).

As discussed, the coupling assembly 100 is formed by attaching the first fitting 105A and the second fitting 105B upon application of a force 103. Such force 103 can be applied along the axial direction 131 (for example, along the-Z direction applied to the second fitting 105B and along the +Z direction applied to the first fitting 105A). The coupling assembly 100 can be a demountable connection, which means that it is made up of components that are detachable from each other. Thus, the first fitting 105A and the second fitting 105B can be detached from each other and the seal 110 can be broken when the target material generator 250 is not in use. Any suitable mechanical device or devices can be used to provide the force 103. In some implementations, the mechanical device is demountable or detachable; in this way, the force 103 can be applied by the mechanical device and can be removed without damaging the coupling assembly 100. For example, the force 103 can be applied using threaded fasteners, pins, retaining rings, clamps, or frictional engagement (such as press-fitting).

The flow conduit 102 is an axial flow path through which the target material 101 can traverse and this axial flow path extends along the axial direction 131. A cross section of the flow conduit 102 can be circular if the inner walls 120A, 120B are cylindrical in shape. The coupling assembly 100 is robust and the sealing functionality of the coupling assembly 100 improves as a pressure of the target material 101 that traverses the axial flow path (the flow conduit 102) increases. The coupling assembly 100 can be a passive device, which means that no additional energy is required for the coupling assembly 100 (and the seal 110) to operate as a sealing mechanism. In this way, the coupling assembly 100 provides a passive pressure energized seal 110.

The first fitting 105A and the second fitting 105B can be made of a material that is compatible with the target material 101 (since they come in contact with the target material 101). Moreover, the first fitting 105A and the second fitting 105B can be made of a material that is suitably resistant to heat, corrosion, and wear to ensure breakdowns are rare and also the material should maintain its strength at all working temperatures. If the target material 101 includes tin, then the first fitting 105A and the second fitting 105B can be made of a refractory metal. In some implementations, the refractory metal used in the first fitting 105A and the second fitting 105B includes molybdenum. In other implementations, the refractory metal used in the first fitting 105A and the second fitting 105B includes tungsten, niobium, tantalum, or rhenium.

Similar to the first fitting 105A and the second fitting 105B, the sleeve 115 can be made of a material that is compatible with the target material 101 (since it comes in contact with the target material 101). Moreover, the sleeve 115 can be made of a material that is suitably resistant to heat, corrosion, and wear to ensure breakdowns are rare and also the material should maintain its strength at all working temperatures. If the target material 101 includes tin, then the sleeve 115 can be made of a refractory metal. In some implementations, the refractory metal used in the sleeve 115 includes tantalum. In other implementations, the refractory metal used in the sleeve 115 includes tungsten, niobium, molybdenum, or rhenium.

The sleeve 115 has an outer diameter OD115 that is less than a diameter D102 of the flow conduit 102. The region 125 is formed between the outer diameter OD115 of the sleeve 115 and the diameter D102 of the flow conduit 102. Thus, the difference between D102 and OD115 should be large enough to enable the region 125 to function as a contaminant trap and receive and trap the unwanted matter 116 within the region 125. The sleeve 115 has a thickness along the radial direction (perpendicular to the Z axis). The diameter D102 of the flow conduit 102 is on the order of several millimeters (mm), such as about 4-8 mm. The thickness of the sleeve 115 is selected based on a few design goals. The first design goal is to maintain an opening that is wide enough to extend the flow conduit 102 and not restrict the flow of the target material 101 through the sleeve 115 along the flow conduit 102. The second design goal is to maintain a strength of the sleeve 115. In some implementations, the thickness of the sleeve 115 is on the order of a mm or a fraction of a mm, for example, the thickness of the sleeve can be 0.5-1.0 mm.

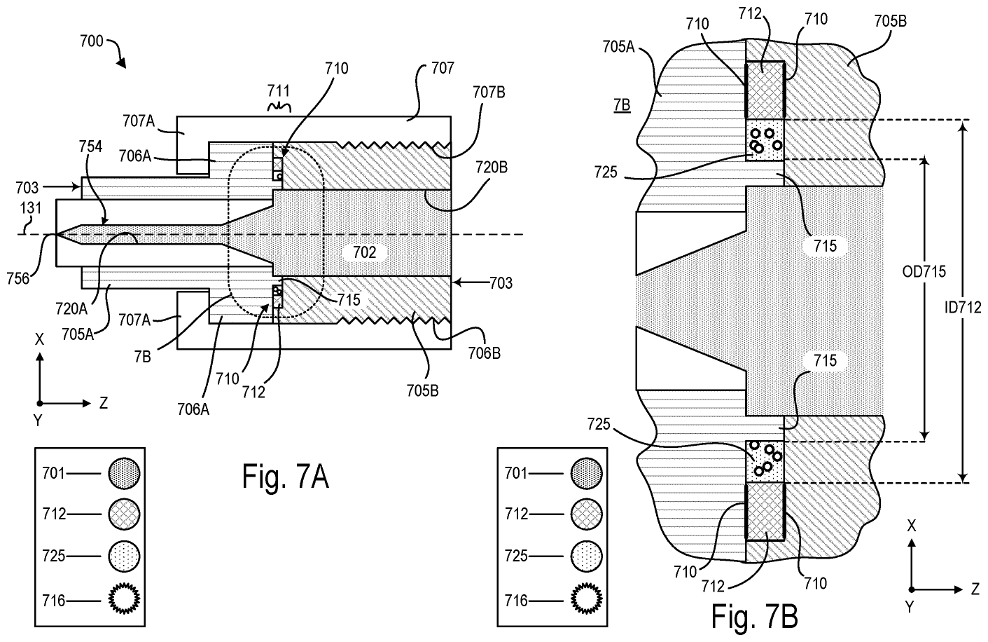

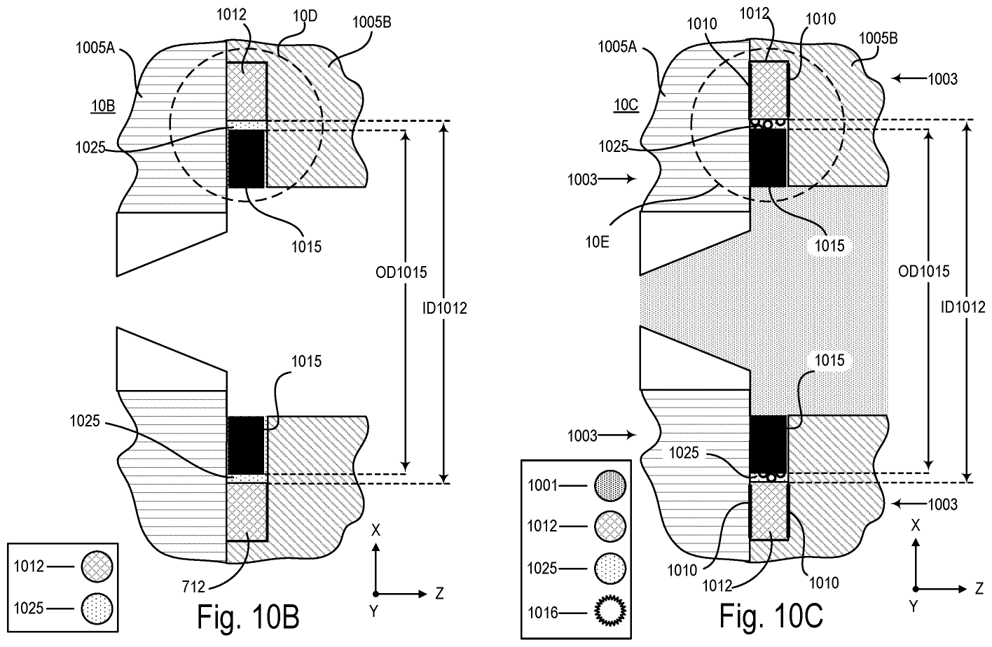

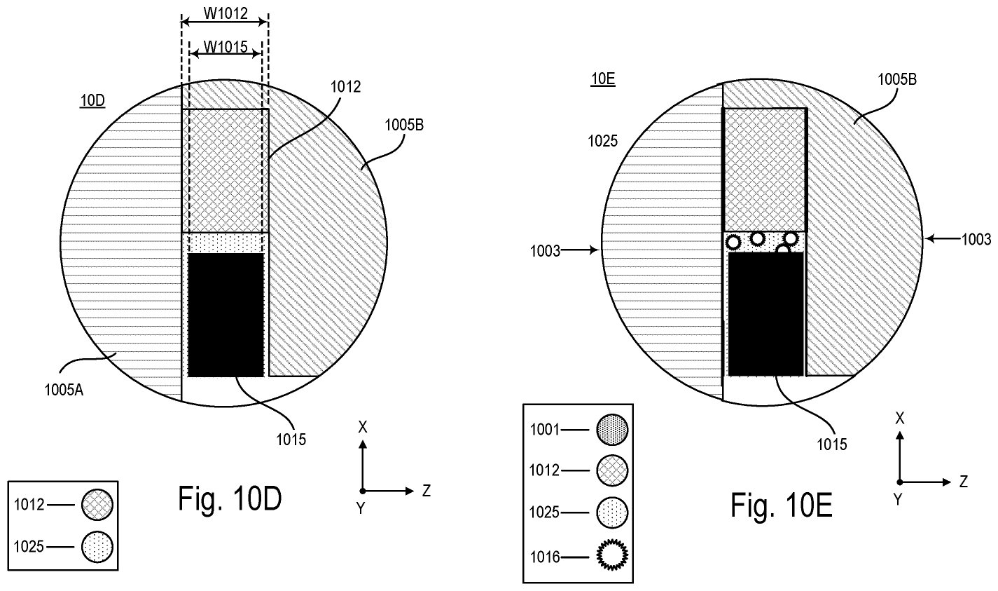

The sleeve 115 can extend axially (that is, along the Z axis) along a distance that is long enough to “cover” the seal 110. In particular, a sleeve 115 that is too short (axially) relative to an axial extent of the seal 110 would fail at trapping enough unwanted matter 116. In some implementations, the sleeve 115 is longer than the seal 110 along the axial direction 131 (along the Z axis), and in some implementations, the sleeve 115 can extend significantly beyond the seal 110 along the axial direction 131. For example, in such implementations, the sleeve 115 can have a length along the axial direction 131 that is at least twice as long, at least three times as long, at least five times as long, or at least ten times as long as a length of the seal 110 along the axial direction 131. In other implementations, such as described below with reference to FIGS. 7A-7B and 10A-10E, the sleeve 115 may be about the same length as or shorter than the seal 110 along the axial direction 131 (along the Z axis). In such implementations, the sleeve 115 can be configured as an extension of the first or second fittings 105A, 105B (FIGS. 7A-7B) or it can be configured as an annular gasket (FIGS. 10A-10E). The length of the sleeve 115 (or of the seal 110) along the axial direction 131 can be referred to as a width of the sleeve 115 (or the seal 110).

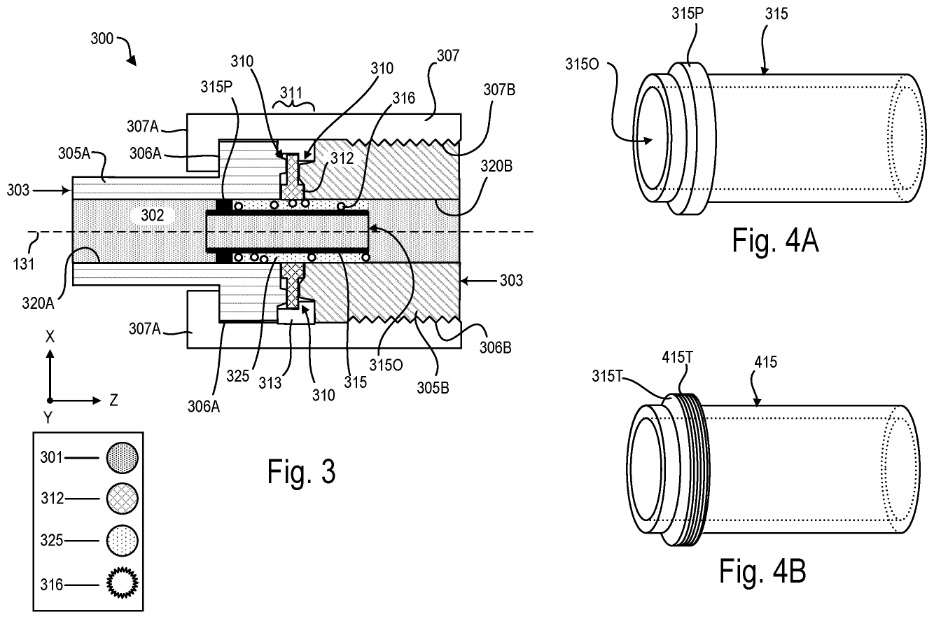

Referring to FIG. 3, an implementation 300 of the coupling assembly 100 is shown, in which a seal 310 is designed or formed at a radial interface 311 between a first fitting 305A and a second fitting 305B. The seal 310 is formed from a sealing device 312 disposed along the radial interface 311 between the first fitting 305A and the second fitting 305B. The sealing device 312 can be a gasket that is placed between the radial surfaces of the first fitting 305A and the second fitting 305B. The gasket 312 has an annular shape, in which the center of the shape aligns with the axial direction 131 and also aligns with the inner walls 320A, 320B. Specifically, a cross section of the gasket 312 in the radial plane (the X-Y plane) is in the shape of an annulus. This annular shape of the gasket 312 defines an inner opening that is large enough to enable target material 301 to pass through the gasket 312 (that is, through the inner opening of the gasket 312). The inner opening of the gasket 312 extends the flow conduit 302 between the first and second fittings 305A, 305B.

The gasket 312 can be arranged in a support component 313, which is also an annular shape, to match or complement the shape of the gasket 312. When the gasket 312 is seated between the first and second fittings 305A, 305B and the seal 310 is formed by attaching the first and second fittings 305A, 305B upon application of the force 303, pressure that is applied to the gasket 312 from any target material 301 traversing the inner opening of the gasket 312 can improve the hermetic function of the seal 310. Specifically, this means that as the pressure increases, the seal 310 can become better able to prevent the passage of the target material 301 through the seal 310 (that is, between the exterior 300 and the flow conduit 302). Thus, as the pressure from the target material 301 increases, leakage of the target material 301 through the seal 310 is reduced. The pressure applied to the gasket 312 due to the flow of the target material 301 through the flow conduit 302 is distinct from the pressure applied to the gasket 312 due to the force 303 applied to the first and second fittings 305A, 305B. In other words, the pressure applied to the gasket 312 from the flow of the target material 301 arises from the force of the target material 301, not from the force 303 applied to the first and second fittings 305A, 305B.

In the coupling assembly 300, the force 303 is applied using a threaded fastener, which is formed between the second fitting 305B and a coupling element 307. In particular, the second fitting 305B includes threads 306B on its exterior cylindrical surface that mate with interior threads 307B of the coupling element 307. The coupling element 307 includes an annular flange 307A that extends radially inwardly and engages an outer radial surface of an annular flange 306A of the first fitting 305A.

The gasket 312 is robust against defects and process. This means that the material of the gasket 312 is better able to comply and deform to account for variations in the materials at the seal 310 and to better seal against such variations (much like a rubber compound). But, the material of the gasket 312 has properties that make it more suitable than rubber compounds traditionally used in rubber O-Rings. For example, the material of the gasket 312 is stronger than a common rubber O-Ring. The material of the gasket 312 is thermally stable, which means its sealing properties do not change significantly with changes in temperature that occur at the seal 310, such temperature changes occurring in part due to the temperature at which the target material 301 is maintained (to keep the target material 301 in a non-solid form). The design and material of the gasket 312 is such that tightening of the seal 310 is a more robust process, producing more consistent joints (at the coupling assembly 300) that are within torque and rotation specifications. The gasket 312 is able to withstand greater elastic strain, and can accommodate several micrometers of fitting expansion, which can occur when the pressure due to the flow of the target material 301 increases or from external loads such as applied as the force 303.

The gasket 312 is made of a material that is compatible with and not reactive to the target material 301 that comes in contact with the gasket 312. Additionally, the material of the gasket 312 is able to withstand the temperature at which the target material 301 needs to be maintained. For example, if the target material 301 includes liquid tin, then the gasket 312 may be made of a material that can withstand operating temperatures of at least 200° C. because tin melts at 232° C. and is maintained at 260° C. to ensure it remains in the form of a liquid. The material of the gasket 312 may be chosen for its ability to withstand the pressure applied to the gasket 312 from the target material 301, such pressure can be greater than or equal to 3000 pounds per square inch (PSI). Moreover, the gasket 312 can be made of a material that retains its sealing properties at flow pressures (of the target material 301) that are greater than 10,000 PSI or greater than 20,000 PSI. That is, the gasket 312 does not crack or rupture, which would lead to leaks, even when the flow pressure (of the target material 301) exceeds 10,000 PSI or exceeds 20,000 PSI. The gasket 312 should be compliant, deformable, and soft enough to compress as the force 303 applied to join the first and second fittings 305A, 305B is increased. The gasket 312 is removable from the interface 311 without causing damage the other components (such as the first and second fittings 305A, 305B) that constitute the seal 310. That is, the gasket 312 is configured to be detachable from the first and second fittings 305A, 305B. For example, in some implementations, the gasket 312 is made of a polyimide-based plastic such as Vespel™.

An example of a gasket 312 is shown in International Pub. No. WO 2022/017866A1, titled ROBUST FLUID COUPLING APPARATUS and published on Jan. 27, 2022, the contents of which is incorporated herein by reference in its entirety.

With additional reference to FIG. 4A, the coupling assembly 300 includes a sleeve 315, which is an implementation of the sleeve 115. Like the sleeve 115, the sleeve 315 is hollow and therefore includes an opening 3150 that aligns with the flow conduit 302 and generally extends along the axial direction 131. The sleeve 315 includes an annular protrusion 315P at one end of the sleeve 315 that is inside the first fitting 305A. The sleeve 315 is coupled to the first fitting 305A by way of a press fitting that is formed between the annular protrusion 315P of the sleeve 315 and the inner wall 320A of the first fitting 305A. The sleeve 315 has a “loose” fit with the second fitting 305B. Such a loose fit with the second fitting 305B enables easier assembly of the sleeve 315 in the flow conduit 302. Moreover, because the loose fit is on the upstream side of the gasket 312 (because, as discussed above, the target material 301 material flows along the-Z direction), the target material 301 is able to flow into the region 325 between the sleeve 315 and the gasket 312 and also between the sleeve 315 and the inner walls 320A, 320B along the axial extent of the sleeve 315. The sleeve 315 acts as a contaminant trap for the unwanted matter 316; in particular, the unwanted matter 316 that is formed at the seal 310 is trapped within the region 325 and also prevented from flowing downstream (along the −Z direction) toward components that are downstream of the coupling assembly 300. In particular, the unwanted matter 316 is blocked from leaving the region 325 in the downstream direction by the annular protrusion 315P, which is press fit within the inner wall 320A of the first fitting 305A such that any gap between the protrusion 315P and the inner wall 320A is smaller than a size of the unwanted matter 316, and, in some implementations, the outer periphery of protrusion 315P is conterminous with (that is, contacts) the inner wall 320A.

In another implementation 415 of the sleeve 315, as shown in FIG. 4B, the annular protrusion 315P is formed as annular protrusion 315T that includes outer threads 415T that mate with threads (not shown) on the inner wall 320A of the first fitting 305A.

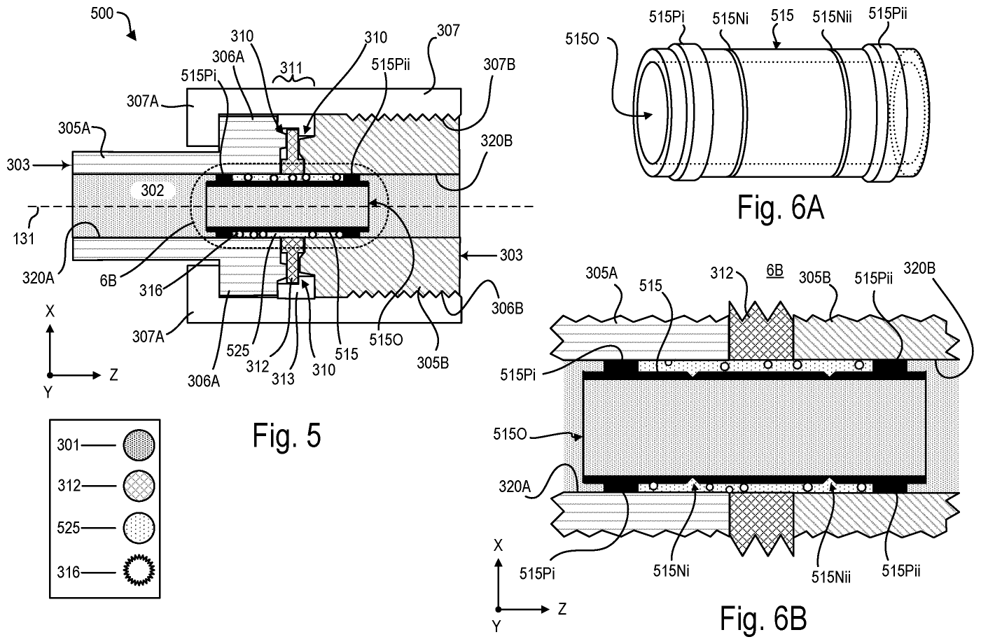

Referring to FIGS. 5, 6A, and 6B, another implementation 515 of the sleeve 315 is shown in an implementation 500 of the coupling assembly 300. Like the sleeve 315, the sleeve 515 is hollow and therefore includes an opening 5150 that aligns with the flow conduit 302 and generally extends along the axial direction 131. The sleeve 515 includes a pair of annular protrusions 515Pi, 515Pii at each end of the sleeve 515. A first protrusion 515Pi is inside the first fitting 305A and a second protrusion 515Pii is inside the second fitting 305B. The sleeve 515 is coupled to both the first fitting 305A and the second fitting 305B by way of a press fitting that is formed between the annular protrusion 515Pi and the inner wall 320A of the first fitting 305A and a press fitting that is formed between the annular protrusion 515Pii and the inner wall 320B of the second fitting 305B. Thus, the sleeve 515 is fit to both the first fitting 305A and the second fitting 305B. The fit between the sleeve 515 and the first fitting 305A and the second fitting 305B is not hermetic (it cannot maintain a pressure differential) but it is snug enough to prevent particles the size of unwanted matter 316 from passing. Any contamination (or unwanted matter 316) that is produced at the seal 310 remains trapped within the region 525 between sleeve 515 and the inner walls 320A, 320B of respective first fitting 305A and second fitting 305B and moreover between the first and second protrusions 515Pi, 515Pii. In this way, any unwanted matter 316 is prevented from flowing downstream (along the −Z direction) toward components that are downstream of the coupling assembly 300. Because there is a press fit at both ends of the region 525, the unwanted mater 316 is not be able to escape regardless of the direction along which the target material 301 flows. In particular, the unwanted matter 316 is blocked from leaving the region 525 in the downstream direction by the annular protrusion 515Pi, which is press fit within the inner wall 320A of the first fitting 305A such that any gap between the protrusion 515Pi and the inner wall 320A is smaller than a size of the unwanted matter 316. Additionally, the unwanted matter is blocked from leaving the region 525 in the upstream direction by the annular protrusion 515Pii, which is press fit within the inner wall 320B of the second fitting 305B such that any gap between the protrusion 515Pii and the inner wall 320B is smaller than a size of the unwanted matter 316. In some implementations, the outer periphery of one or both protrusions 515Pi and 515Pii are conterminous with (that is, contact) the inner wall 320A.

Thus, the unwanted matter 116 would remain in the region 525 even if the target material 301 is flowing along the +Z direction.

Because the sleeve 515 makes contact at two locations along the flow conduit 302 (namely, at the locations of the first and second protrusions 515Pi, 515Pii), it can be a challenge to assemble the coupling assembly 500 and to fit the sleeve 515 within the flow conduit 302. In some implementations, the sleeve 515 can be made thinner so as to accommodate some flexibility during assembly. For example, the thickness of the sleeve 515 can be reduced below 0.5 mm. In other implementations, the sleeve 515 can include annular notches 515Ni, 515Nii (FIGS. 6A and 6B) to allow for coaxial misalignment within the flow conduit 302. The annular notches 515Ni, 515Nii increase flexibility in local areas (the regions near the notches 515Ni, 515Nii) of the sleeve 515 to facilitate flexibility during assembly. The sleeve 515 can include more than two annular notches, or it can be designed with a bellows profile having a plurality of annular notches positioned between the protrusions 515Pi, 515Pii.

Referring to FIGS. 7A and 7B, an implementation 700 of the coupling assembly 100 is shown in which the sleeve 115 is formed as an annular shoulder 715 machined into a first fitting 705A. The sleeve 715 is at a radial interface 711 between the first fitting 705A and a second fitting 705B. As shown, the coupling assembly 700 provides a passage or flow conduit 702 through which target material 701 passes on the way to the external system 252 (FIG. 2). A seal 710 is formed from a sealing device 712 disposed along the radial interface 711 between the first fitting 705A and the second fitting 705B. The sealing device 712 can be a gasket that is placed between the radial surfaces of the first fitting 705A and the second fitting 705B that abut each other. The gasket 712 has an annular shape, in which the center of the shape aligns with the axial direction 131. Specifically, a cross section of the gasket 712 in the radial plane (the X-Y plane) is in the shape of an annulus. This annular shape of the gasket 712 defines an inner opening having an inner diameter ID712 that is larger than an outer diameter OD715 of the sleeve 715. The annular gap between the gasket 712 and the sleeve 715 (which correlates with the difference between the OD715 and the ID712) forms the region 725 (shown more clearly in FIG. 7B), which is large enough to enable unwanted matter 716 (which is produced at the seal 710 and in particular, the gasket 712) to be trapped within this region 725.

When the gasket 712 is seated between the first and second fittings 705A, 705B, the seal 710 is formed by attaching the first and second fittings 705A, 705B upon application of the force 703. In the coupling assembly 700, similarly to the coupling assembly 300, the force 703 is applied using a threaded fastener, which is formed between the second fitting 705B and a coupling element 707. In particular, the second fitting 705B includes threads 706B on its exterior cylindrical surface that mate with interior threads 707B of a coupling element 707. The coupling element 707 includes an annular flange 707A that extends radially inwardly and engages an outer radial surface of an annular flange 706A of the first fitting 705A.

Like the gasket 312, the gasket 712 is robust against defects and process, is better able to comply and deform to account for variations in the materials at the seal 710 and to better seal against such variations (much like a rubber compound). But, the material of the gasket 712 has properties that make it more suitable than rubber compounds traditionally used in rubber O-Rings, and the material of the gasket 712 is stronger than a common rubber O-Ring. The material of the gasket 712 is thermally stable, which means its sealing properties do not change significantly with changes in temperature that occur at the seal 710, such temperature changes occurring in part due to the temperature at which the target material 701 is maintained (to keep the target material 701 in a non-solid or fluid form). The design and material of the gasket 712 is such that tightening of the seal 710 is a more robust process, producing more consistent joints (at the coupling assembly 700) that are within torque and rotation specifications. The gasket 712 is able to withstand greater elastic strain, and can accommodate several micrometers of fitting expansion, which can occur when the pressure due to the flow of the target material 701 increases or from external loads such as applied as the force 703. The gasket 712 can be made of a material that is compatible with and not reactive to the target material 701 or any other material that comes in contact with the gasket 712. Additionally, the material of the gasket 712 is able to withstand the temperature at which the target material 701 needs to be maintained. For example, if the target material 701 includes liquid tin, then the gasket 712 should be made of a material that can withstand operating temperatures of at least 200° C. because tin melts at 232° C. and is maintained at 260° C. to ensure it remains in the form of a liquid. The material of the gasket 712 should be able to withstand the pressure applied to it due to the force 703, and also pressure applied to it from the target material 701, such pressure being greater than or equal to 3000 pounds per square inch (PSI). Moreover, the gasket 712 can be made of a material that retains its sealing properties at flow pressures (of the target material 701) that are greater than 10,000 PSI or greater than 20,000 PSI. That is, the gasket 712 does not crack or rupture, which would lead to leaks, even when the flow pressure (of the target material 701) exceeds 10,000 PSI or exceeds 20,000 PSI.

The gasket 712 is formed of a material that is compliant, deformable, and soft enough to compress as the force 703 applied to join the first and second fittings 705A, 705B is increased. The gasket 712 is removable from the interface 711 without causing damage the other components (such as the first and second fittings 705A, 705B) that constitute the seal 710. That is, the gasket 712 is configured to be detachable from the first and second fittings 705A, 705B. For example, in some implementations, the gasket 712 is made of a polyimide-based plastic such as Vespel™.

The sleeve 715 is a part of the first fitting 705A. In some implementations, the first fitting 705A and therefore the sleeve 715 are made of a refractory metal such as molybdenum, tantalum, tungsten, niobium, or rhenium. Notably, a hermetic seal is not formed at the interface between the sleeve 715 and the second fitting 705B. Thus, a pressure differential is not maintained at this interface. Rather, the pressure differential is maintained at the seal 710. Nevertheless, the sleeve 715 acts to prevent the unwanted matter 716 from escaping into the flow conduit 702 (and therefore into the first fitting 705A) because of the geometry of the sleeve 715. In particular, the sleeve acts in a manner such that the Venturi effect occurs and prevents the unwanted matter 716 from flowing from the gasket 712 to the first fitting 705A.

Referring again to FIG. 2, the coupling assembly 700 can be a part of a nozzle supply apparatus 260 of the target material generator 250. In such implementation, the first fitting 705A houses a capillary 754 that is a part of a nozzle assembly at the exit of the nozzle supply apparatus 260. Target material 701 (or 101) that passes through the coupling assembly 700 exits the target material generator 250 through an opening 756 of the capillary 754 on its way to the external system 252 (FIG. 2). The flow of the target material 701 through the coupling assembly 700 is therefore along the-Z direction from the second fitting 705B, through the capillary 754, and through the opening 756. A flow conduit 702 is formed by and defined by inner walls 720A, 720B of respective capillary 754 (fitted within the first fitting 705A) and second fitting 705B.

In one example, which is discussed in more detail below, the external system 252 is an EUV light source, and the nozzle supply apparatus 260 can emit a stream of targets 264 made from the target material 101 (or 701) such that a target is delivered to a plasma formation location 266 in a vacuum chamber 268 of the EUV light source. Each target 264 can be provided to the plasma formation location 266 by passing molten target material 101 (or 701) through the nozzle assembly (that is, the capillary 754) of the nozzle supply apparatus 260, and allowing the target 264 to drift along a trajectory to the plasma formation location 266. In some implementations, the target 264 can be directed to the plasma formation location 266 by force.

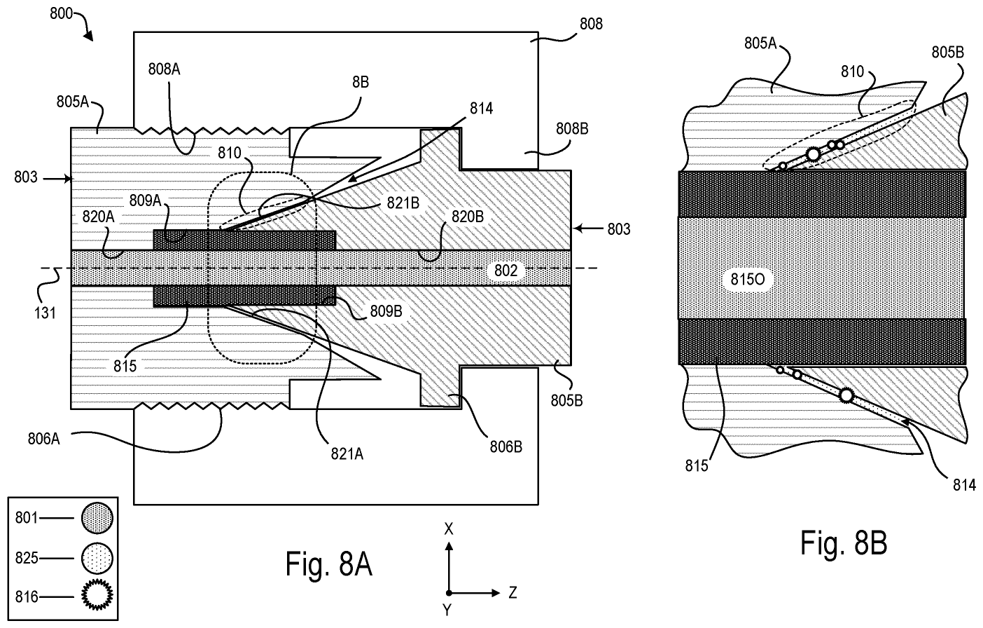

Referring to FIGS. 8A and 8B, another implementation 800 of the coupling assembly 100 is shown. In the coupling assembly 800, a seal 810 is a cone and thread seal, and is designed or formed at an interface 814 between two conical and angled surfaces 821A, 821B of respective first fitting 805A and second fitting 805B. The seal 810 is formed without any other use of a sealing device between the first fitting 805A and the second fitting 805B. In particular, the seal 810 is formed by attaching the first and second fittings 805A, 805B by application of the force 803. The force 803 is applied using a threaded fastener, which is formed between the first fitting 805A and a coupling element 808. In particular, the first fitting 805A includes threads 806A on its exterior cylindrical surface that mate with interior threads 808A of the coupling element 808. Moreover, the coupling element 808 includes an annular flange 808B that extends radially inwardly (in the XY plane) and engages an outer surface of an annular radial flange 806B of the second fitting 805B.

The coupling assembly 800 includes a sleeve 815, which is an implementation of the sleeve 115. Like the sleeve 115, the sleeve 815 is hollow and therefore includes an opening 8150 that aligns with the flow conduit 802 and generally extends along the axial direction 131. The flow conduit 802 is defined by the inner walls 820A, 820B of respective first fitting 805A and second fitting 805B. Like the coupling assembly 100, the flow conduit 802 is cylindrical and the sleeve 815 is cylindrical. The sleeve 815 fits within a cavity that is formed by respective recesses 809A, 809B of the first fitting 805A and the second fitting 805B. In some implementations, the sleeve 815 is coupled into this cavity by press fitting the sleeve 815 into the recess 809A of the first fitting 805A. In other implementations, the sleeve 815 is coupled into the cavity by threading the sleeve 815 into the recess 809A of the first fitting 805A and the first fitting 805 includes threads that mate with the threads on the sleeve 815. The sleeve 815 would have a loose fit with the recess 809B of the second fitting 805B. A loose fit at one of the recesses (such as at the recess 809B) ensures that the seal 810 remains between the two conical surfaces 821A, 821B. Moreover, the loose fit at one of the recesses (such as at the recess 809B) enables easier assembly of the sleeve 815, the first fitting 805A, and the second fitting 805B. The sleeve 815 acts as a contaminant trap for the unwanted matter 816 such that the unwanted matter 816 that is formed at the seal 810 is trapped within a region 825 and prevented from flowing back into the flow conduit 802 and downstream (along the-Z direction) toward components that are downstream of the coupling assembly 800.

In other implementations, the sleeve 815 is fitted into the recess of the second fitting 805B (for example, by press fitting or threading) while having a loose fit in the recess of the first fitting 805A.

The cone and thread seal 810 can hold pressures that are greater than 10,000 PSI, greater than 15,000 PSI, greater than 20,000 PSI, greater than 30,000 PSI, greater than 40,000 PSI, and even as high as 60,000 PSI. The cone and thread seal 810 is used in place of using a sealing device (such as the gasket 312 or the gasket 712). Because the cone and thread seal 810 lacks the material of the gasket 312, 712, there is less chance of oxides of the target material 801 being formed at the seal 810. The unwanted matter 816 is prevented from accessing the flow conduit 802 because it is blocked by the seal 810 as well as the sleeve 815.

Referring again to FIG. 2, the coupling assembly 100 (which can be any of 300, 700, 800) can be used at any one or more locations along a fluid flow path of the target material 101 that is produced in the target material generator 250. One coupling assembly 100 is shown in block diagram within a section of the generator 250 between a reservoir 258 and the nozzle supply apparatus 260. As noted above with reference to FIGS. 7A and 7B, the coupling assembly 700 can be integrated within the nozzle supply apparatus 260, and specifically the capillary 754 of the nozzle assembly can be integral to the first fitting 705A. The coupling assembly 100 can be positioned at any location within the generator 250 where the two fittings meet with the goal to both seal the interface between those two fittings and also to reduce unwanted matter 116 from entering into the flow conduit 102. Importantly, the coupling assembly 100 is designed to reduce the amount of unwanted matter 116 that reaches the capillary 754, and thus prevent the capillary 754 from becoming clogged, which would require the entire nozzle supply apparatus 260 to be opened and require a replacement of the first fitting 705A (FIG. 7A).

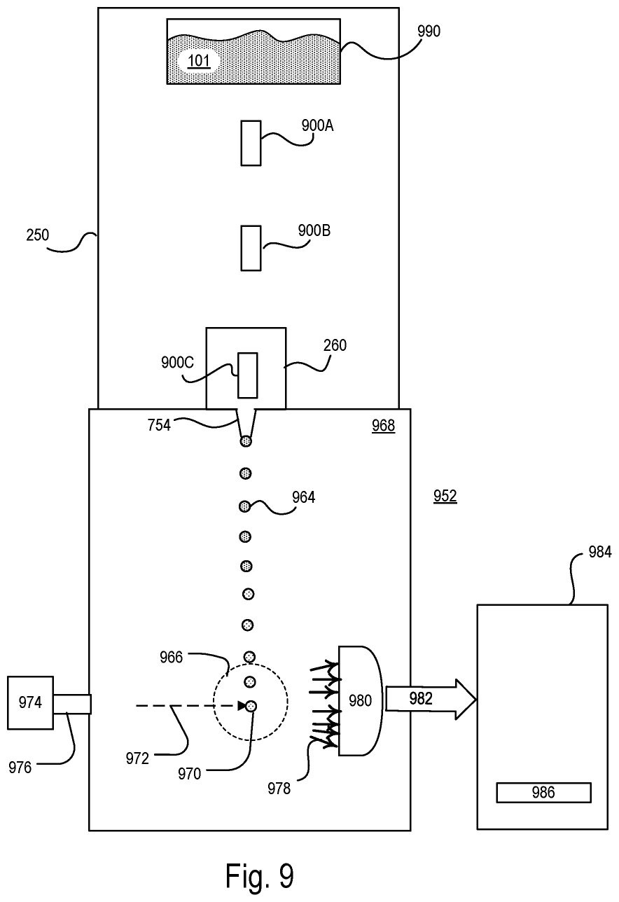

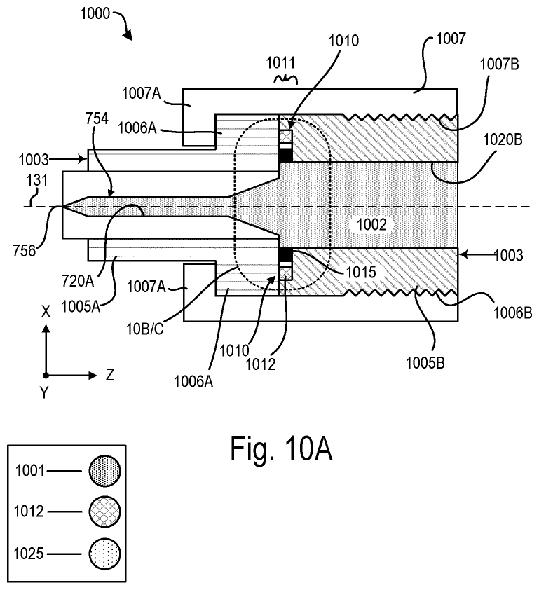

Referring to FIG. 9, in some implementations in which the external system 252 is an EUV light source 952, the target material generator 250 prepares target material 101 from at least one reservoir system 990 and supplies a stream of targets 964, which are made from the target material 101, to a plasma formation location 966 in a vacuum chamber 968 of the EUV light source 952. A target 970 is delivered to the plasma formation location 966. The plasma formation location 966 receives at least one light beam 972 that has been generated by an optical source 974 and delivered to the vacuum chamber 968 by way of an optical path 976. An interaction between the light beam 972 and the target material in the target 970 produces a plasma that emits EUV light 978, which is collected 980 and the collected EUV light 982 is supplied to a lithography exposure apparatus 984. In this example, the target material 101 can be any material that emits the EUV light 978 when in a plasma state. For example, the target material 101 can include water, tin, lithium, xenon, and/or any material that, when converted to a plasma state, has an emission line in the EUV range. For example, the target material 101 can be the element tin, which can be used as pure tin (Sn); as a tin compound, for example, SnBr4, SnBr2, SnH4; as a tin alloy, for example, tin-gallium alloys, tin-indium alloys, tin-indium-gallium alloys, or any combination of these alloys.

The lithography exposure apparatus 984 uses this EUV light 982 to create a pattern on a wafer 986, using any number of process steps, which can be one or more of a combination of process steps such as etching, deposition, and lithography processes with a different mask to create a pattern of openings (such as grooves, channels, or holes) in the material of the wafer 986 or in materials deposited on the wafer 986.

One or more of the coupling assemblies 900A, 900B, 900C (such as the coupling assemblies 100, 300, 700, 800) can be placed in the fluid flow path of the target material 101 from the reservoir system 990 to the nozzle supply apparatus 260. The use of the coupling assembly 900A, 900B, 900C (100, 300, 700, 800) in the target material generator 250 leads to an increase in the power output from and the performance of the EUV light source 952, including reduced failures at the target material generator 250, and a reduction in down time for operating the EUV light source 952. Such improvements are a result of the nozzle supply apparatus 260 providing a continuous and adjustable flow of targets 964. In particular, the pressure applied to the target material 101 that flows within the target material generator 250 can be adjusted and scaled up because the coupling assembly 900A, 900B, 900C reduces the unwanted matter 116 (FIG. 1A) within the target material generator 250 and also the nozzle supply apparatus 260 is less likely to fail at higher fluid pressures Pf because of this. While three coupling assemblies 900A, 900B, 900C are shown in FIG. 9, fewer than three or more than three can be incorporated within the target material generator 250.

In one particular implementation of the coupling assembly 100 (FIG. 1A) or 900A, 900B, 900C, the target material 101 is molten tin; the seal 110 is made of polyimide (such as described with reference to FIG. 3); and the sleeve 115 is made of tantalum.

Other implementations are within the scope of the following claims. For example, with reference to FIGS. 1A and 1B, in other implementations, the cross section of the sleeve 115 and the flow conduit 102 (taken along the XY plane) can take a form other than a circle. For example, the cross section of the sleeve 115 and the flow conduit 102 can be an oval or polygonal.

Referring to FIG. 10A, another implementation 1000 of the coupling assembly 100 is shown in which the sleeve 115 (of FIG. 1A) is formed as an annular gasket 1015 positioned between a first fitting 1005A and a second fitting 1005B. The coupling assembly 1000 is similar to the coupling assembly 700 shown in FIG. 7A, except that the annular shoulder 715 is replaced by the annular gasket 1015, which is distinct from the rest of the first fitting 1005A. Accordingly, the coupling assembly 1000 can be a part of a nozzle supply apparatus 260 of the target material generator 250 (FIG. 2). In such implementation, the first fitting 1005A houses a capillary 754 that is a part of a nozzle assembly at the exit of the nozzle supply apparatus 260. The coupling assembly 1000 provides a passage or flow conduit 1002 through which target material 1001 passes on the way to the external system 252 (FIG. 2). The target material 1001 (or 101) that passes through the coupling assembly 1000 exits the target material generator 250 through an opening 756 of the capillary 754 on its way to the external system 252 (FIG. 2). The flow of the target material 1001 through the coupling assembly 1000 is therefore through the flow conduit 1002 along the-Z direction from the second fitting 1005B, through the capillary 754, and through the opening 756. The flow conduit 1002 is formed by and defined by inner walls 720A, 1020B of respective capillary 754 (fitted within the first fitting 1005A) and second fitting 1005B.

The annular gasket 1015 is at a radial interface 1011 between the first fitting 1005A and the second fitting 1005B. A seal 1010 is formed from a sealing device 1012 disposed along the radial interface 1011 between the first fitting 1005A and the second fitting 1005B. The sealing device 1012 is similar to the sealing device 712 of the coupling assembly 700, and thus, the sealing device 1012 can be a sealing gasket that is placed between the radial surfaces of the first fitting 1005A and the second fitting 1005B that abut each other. The sealing gasket 1012 has an annular shape, in which the center of the shape aligns with the axial direction 131. Specifically, a cross section of the sealing gasket 1012 in the radial plane (the X-Y plane) is in the shape of an annulus.

As shown in FIGS. 10B and 10C, this annular shape of the sealing gasket 1012 defines an inner opening having an inner diameter ID1012 that is slightly larger than an outer diameter OD1015 of the annular gasket 1015. The annular gap between the sealing gasket 1012 and the annular gasket 1015 (which correlates with the difference between the OD1015 and the ID1012) forms the region 1025 (shown more clearly in FIGS. 10B and 10C), which is just large enough to enable unwanted matter 1016 (which is produced at the seal 1010 and in particular, the sealing gasket 1012) to be trapped within this region 1025.

When the sealing gasket 1012 is seated between the first and second fittings 1005A, 1005B and peripherally outside of annular gasket 1015, the seal 1010 is formed by attaching the first and second fittings 1005A, 1005B upon application of the force 1003. In FIG. 10B, the force 1003 is not applied and the seal 1010 is not formed, while in FIG. 10C, the force 1003 is applied and the seal 1010 is formed. In the coupling assembly 1000, similarly to the coupling assembly 300, the force 1003 can be applied using a threaded fastener, which is formed between the second fitting 1005B and a coupling element 1007 (FIG. 10A). In particular, the second fitting 1005B includes threads 1006B on its exterior cylindrical surface that mate with interior threads 1007B of the coupling element 1007. The coupling element 1007 includes an annular flange 1007A that extends radially inwardly and engages an outer radial surface of an annular flange 1006A of the first fitting 1005A.

Like the gasket 312, the sealing gasket 1012 is robust against defects and process, is better able to comply and deform to account for variations in the materials at the seal 1010 (FIG. 10C) and to better seal against such variations (much like a rubber compound). But, the material of the sealing gasket 1012 has properties that make it more suitable than rubber compounds traditionally used in rubber O-Rings, and the material of the sealing gasket 1012 is stronger than a common rubber O-Ring. The material of the sealing gasket 1012 is thermally stable, which means its sealing properties do not change significantly with changes in temperature that occur at the seal 1010, such temperature changes occurring in part due to the temperature at which the target material 1001 is maintained (to keep the target material 1001 in a non-solid or fluid form). The design and material of the sealing gasket 1012 is such that tightening of the seal 1010 is a more robust process (from FIG. 10B to FIG. 10C), producing more consistent joints (at the coupling assembly 1000) that are within torque and rotation specifications. The sealing gasket 1012 is able to withstand greater elastic strain, and can accommodate several micrometers of fitting expansion, which can occur when the pressure due to the flow of the target material 1001 increases or from external loads such as applied as the force 1003. The sealing gasket 1012 can be made of a material that is compatible with and not reactive to the target material 1001 or any other material that comes in contact with the sealing gasket 1012. Additionally, the material of the sealing gasket 1012 is able to withstand the temperature at which the target material 1001 needs to be maintained. For example, if the target material 1001 includes liquid tin, then the sealing gasket 1012 should be made of a material that can withstand operating temperatures of at least 200° C. or at least 230° C. because tin melts at 232° C. and is maintained at 260° C. to ensure it remains in the form of a liquid. The material of the sealing gasket 1012 should be able to withstand the pressure applied to it due to the force 1003, and also pressure applied to it from the target material 1001, such pressure being greater than or equal to 3000 pounds per square inch (PSI). Moreover, the sealing gasket 1012 can be made of a material that retains its sealing properties at flow pressures (of the target material 1001) that are greater than 10,000 PSI or greater than 20,000 PSI. That is, the sealing gasket 1012 does not crack or rupture, which would lead to leaks, even when the flow pressure (of the target material 1001) exceeds 10,000 PSI or exceeds 20,000 PSI.

The sealing gasket 1012 is formed of a material that is compliant, deformable, and soft enough to compress as the force 1003 applied to join the first and second fittings 1005A, 1005B is increased (for example, from FIG. 10B to FIG. 10C). The sealing gasket 1012 is removable from the interface 1011 without causing damage the other components (such as the first and second fittings 1005A, 1005B) that constitute the seal 1010. That is, the sealing gasket 1012 is configured to be detachable from the first and second fittings 1005A, 1005B. For example, in some implementations, the sealing gasket 1012 is made of a polyimide such as a polyimide-based plastic such as Vespel™.

The annular gasket 1015 is separate from the first fitting 1005A and the second fitting 1005B. In some implementations, the annular gasket 1015 is made of a refractory metal such as molybdenum, tantalum, tungsten, niobium, or rhenium. In one particular implementation, the annular gasket 1015 is made of tantalum. Notably, a hermetic seal is not formed at the interface between the annular gasket 1015 and the first fitting 1005A and the second fitting 1005B. Thus, a pressure differential is not maintained at this interface. Rather, the pressure differential is maintained at the seal 1010. Nevertheless, the annular gasket 1015 acts to prevent the unwanted matter 1016 from escaping from the region 1025 into the flow conduit 1002 and therefore is also prevented from entering the first fitting 1005A and the capillary 754 because of the geometry of the annular gasket 1015. In particular, the annular gasket 1015 acts in a manner such that the Venturi effect occurs and prevents the unwanted matter 1016 from flowing from the sealing gasket 1012 to the first fitting 1005A.

Referring to FIG. 10D (which is a close-up view of FIG. 10B), in order to maintain the seal and pressure differential at the seal 1010 as opposed to the interface at the annular gasket 1015, a width W1012 of the sealing gasket 1012, taken along the Z direction, is larger than a width W1015 of the annular gasket 1015, taken along the Z direction before application of the force 1003 (that is, while they are in a relaxed and non-compressed state). Upon application of the force 1003, as shown in FIG. 10E (which is a close-up view of FIG. 10C), the sealing gasket 1012 is therefore compressed prior to the compression of the annular gasket 1015 to thereby form the seal 1010 at the sealing gasket 1012. The implementations can be further described using the following clauses.

1. A high pressure coupling assembly comprising:
a first fitting coupled to a second fitting and forming a molten tin flow conduit therebetween;

a polyimide sealing member disposed between the first and second fittings; and
a tantalum sleeve disposed along inner walls of the flow conduit and disposed between the polyimide sealing member and the flow conduit;
wherein the tantalum sleeve is coupled to one or more of the first and second fittings by press-fitting or threading.
   2. The high pressure coupling assembly of clause 1, wherein the first fitting and the second fitting comprise molybdenum.
   3. The high pressure coupling assembly of clause 1, wherein the tantalum sleeve is configured to trap contaminants within a region between the sleeve and the inner walls of the conduit.
   4. The high pressure coupling assembly of clause 3, wherein the tantalum sleeve includes at least one protrusion that extends across the region and circumferentially contacts an inner wall of the flow conduit.
   5. The high pressure coupling assembly of clause 3, wherein the tantalum sleeve includes two annular protrusions at each axial end of the tantalum sleeve, each annular protrusion circumferentially contacting an inner wall of the flow conduit.
   6. The high pressure coupling assembly of clause 1, wherein the polyimide sealing member is configured to maintain a hermetic seal up to pressures greater than 10,000 pounds per square inch (PSI), greater than 20,000 PSI, or greater than 30,000 PSI.
   7. The high pressure coupling assembly of clause 1, wherein an outer diameter of the tantalum sleeve is less than a diameter of the flow conduit.
   8. The high pressure coupling assembly of clause 1, wherein the tantalum sleeve extends a length along the flow conduit that is greater than a length along which the polyimide sealing member extends.
   9. A coupling assembly for an extreme ultraviolet light source target material generator, the coupling assembly comprising:
a first fitting coupled to a second fitting and forming a flow conduit therebetween, wherein a seal is formed between the first fitting and the second fitting; and
a sleeve disposed along inner walls of the flow conduit and between the seal and the flow conduit such that a contaminant trap is formed between the sleeve and the seal.
   10. The coupling assembly of clause 9, wherein the sleeve is coupled to one or more of the first fitting and the second fitting by press-fitting or threading.
   11. The coupling assembly of clause 9, further comprising a sealing device disposed between the first fitting and the second fitting, the sealing device forming the seal between the first fitting and the second fitting.
   12. The coupling assembly of clause 11, wherein the sealing device comprises a gasket placed between the first fitting and the second fitting.
   13. The coupling assembly of clause 12, wherein the gasket comprises polyimide.
   14. The coupling assembly of clause 9, wherein the first fitting and the second fitting are press fitted together or are threaded together to thereby form the seal at the interface between the first fitting and the second fitting.
   15. The coupling assembly of clause 9, wherein the first fitting and the second fitting comprise a refractory metal.
   16. The coupling assembly of clause 15, wherein the refractory metal of the first fitting and the second fitting comprises molybdenum.
   17. The coupling assembly of clause 9, wherein the sleeve comprises a material that is compatible with fluid flowing within the flow conduit.
   18. The coupling assembly of clause 9, wherein the sleeve is configured to trap contaminants within a region between the sleeve and the inner walls of the flow conduit, some of the contaminants being formed from the interaction between the seal and a target material flowing within the flow conduit.
   19. The coupling assembly of clause 18, wherein the sleeve includes at least one protrusion that extends across the region and circumferentially contacts an inner wall of the flow conduit.
   20. The coupling assembly of clause 9, wherein the sleeve comprises a refractory metal.
   21. The coupling assembly of clause 9, wherein the sleeve comprises tantalum.
   22. The coupling assembly of clause 9, wherein the seal is directly formed between a first conical surface of the first fitting and a second conical surface of the second fitting when the first conical surface and the second conical surface are frictionally engaged.
   23. The coupling assembly of clause 9, wherein the sleeve is an annular protrusion of the first fitting.
   24. The coupling assembly of clause 9, wherein the sleeve is an annular gasket positioned between the first fitting and the second fitting.
   25. The coupling assembly of clause 24, further comprising a sealing gasket disposed between the first fitting and the second fitting, the sealing gasket forming the seal between the first fitting and the second fitting.
   26. The coupling assembly of clause 25, wherein the annular gasket comprises tantalum and the sealing gasket comprises polyimide.
   27. The coupling assembly of clause 25, wherein the annular gasket is disposed concentrically inside the sealing gasket.
   28. The coupling assembly of clause 25, wherein a width of the sealing gasket, when in a relaxed state, is greater than a width of the annular gasket, when in a relaxed state.
   29. A target material generator for an extreme ultraviolet light source, the target material generator comprising:
a fluid flow path between reservoir system and a nozzle supply system; and
a coupling assembly in the fluid flow path, the coupling assembly comprising:
a first fitting coupled to a second fitting to thereby form a flow conduit along the fluid flow path,
wherein a seal is formed between the first fitting and the second fitting; and
a sleeve disposed along inner walls of the flow conduit and between the seal and the flow conduit such that a contaminant trap is formed between the sleeve and the seal.
   30. The target material generator of clause 29, wherein the fluid flow path provides a path for target material from the reservoir system to and through the nozzle supply system.
   31. The target material generator of clause 29, wherein the target material comprises tin or a tin alloy.
   32. The target material generator of clause 29, wherein the sleeve is coupled to the first and second fittings by press-fitting or threading.
   33. The target material generator of clause 29, wherein the coupling assembly comprises a sealing device disposed between the first fitting and the second fitting, the sealing device forming the seal between the first fitting and the second fitting.
   34. The target material generator of clause 33, wherein the sealing device comprises a gasket placed between the first fitting and the second fitting.
   35. The target material generator of clause 29, wherein the first fitting and the second fitting are press fitted together or are threaded together to thereby form the seal at the interface between the first fitting and the second fitting.
   36. The target material generator of clause 29, wherein the first fitting and the second fitting comprise a refractory metal.
   37. The target material generator of clause 29, wherein the sleeve comprises a material that is compatible with target material flowing along the fluid flow path between the reservoir system and the nozzle supply system.
   38. The target material generator of clause 29, wherein the sleeve is configured to trap contaminants within a region between the sleeve disposed and the inner walls of the flow conduit, some of the contaminants being formed from the interaction between the seal and a target material flowing within the flow conduit and along the fluid flow path between the reservoir and the nozzle supply system.
   39. The target material generator of clause 38, wherein the sleeve includes at least one protrusion that extends across the region and completely circumferentially contacts an inner wall of the flow conduit.

The above described implementations and other implementations are within the scope of the following claims.

1-8. (canceled)

9. A coupling assembly for an extreme ultraviolet light source target material generator, the coupling assembly comprising:
a first fitting coupled to a second fitting and forming a flow conduit therebetween, wherein a seal is formed between the first fitting and the second fitting; and
a sleeve disposed along inner walls of the flow conduit and between the seal and the flow conduit such that a contaminant trap is formed between the sleeve and the seal.

10. (canceled)

11. The coupling assembly of claim 9, further comprising a sealing device disposed between the first fitting and the second fitting, the sealing device forming the seal between the first fitting and the second fitting.

12. The coupling assembly of claim 11, wherein the sealing device comprises a gasket placed between the first fitting and the second fitting.

13. The coupling assembly of claim 12, wherein the gasket comprises polyimide.

14. (canceled)

15. The coupling assembly of claim 9, wherein the first fitting and the second fitting comprise a refractory metal.

16. The coupling assembly of claim 15, wherein the refractory metal of the first fitting and the second fitting comprises molybdenum.

17. (canceled)

18. The coupling assembly of claim 9, wherein the sleeve is configured to trap contaminants within a region between the sleeve and the inner walls of the flow conduit, some of the contaminants being formed from the interaction between the seal and a target material flowing within the flow conduit.

19. The coupling assembly of claim 18, wherein the sleeve includes at least one protrusion that extends across the region and circumferentially contacts an inner wall of the flow conduit.

20. (canceled)

21. (canceled)

22. The coupling assembly of claim 9, wherein the seal is directly formed between a first conical surface of the first fitting and a second conical surface of the second fitting when the first conical surface and the second conical surface are frictionally engaged.

23. The coupling assembly of claim 9, wherein the sleeve is an annular protrusion of the first fitting.

24. The coupling assembly of claim 9, wherein the sleeve is an annular gasket positioned between the first fitting and the second fitting.

25. The coupling assembly of claim 24, further comprising a sealing gasket disposed between the first fitting and the second fitting, the sealing gasket forming the seal between the first fitting and the second fitting.

26. (canceled)

27. The coupling assembly of claim 25, wherein the annular gasket is disposed concentrically inside the sealing gasket.

28. The coupling assembly of claim 25, wherein a width of the sealing gasket, when in a relaxed state, is greater than a width of the annular gasket, when in a relaxed state.

29. A target material generator for an extreme ultraviolet light source, the target material generator comprising:
a fluid flow path between reservoir system and a nozzle supply system; and
a coupling assembly in the fluid flow path, the coupling assembly comprising:
a first fitting coupled to a second fitting to thereby form a flow conduit along the fluid flow path, wherein a seal is formed between the first fitting and the second fitting; and
a sleeve disposed along inner walls of the flow conduit and between the seal and the flow conduit such that a contaminant trap is formed between the sleeve and the seal. 30-32. (canceled)

33. The target material generator of claim 29, wherein the coupling assembly comprises a sealing device disposed between the first fitting and the second fitting, the sealing device forming the seal between the first fitting and the second fitting.

34. The target material generator of claim 33, wherein the sealing device comprises a gasket placed between the first fitting and the second fitting.

35. The target material generator of claim 29, wherein the first fitting and the second fitting are press fitted together or are threaded together to thereby form the seal at the interface between the first fitting and the second fitting.

36. The target material generator of claim 29, wherein the first fitting and the second fitting comprise a refractory metal.

37. (canceled)

38. The target material generator of claim 29, wherein the sleeve is configured to trap contaminants within a region between the sleeve disposed and the inner walls of the flow conduit, some of the contaminants being formed from the interaction between the seal and a target material flowing within the flow conduit and along the fluid flow path between the reservoir and the nozzle supply system.

39. (canceled)
